(19) United States
(12) Patent Application Publication
(10) Pub. No.: US 2015/0305830 A1
(43) Pub. Date: Oct. 29, 2015

(54) TOOTH POSITIONING APPLIANCE AND USES THEREOF

(71) Applicants: Eric Howard, Lititz, PA (US); Phillip Getto, Dallas, TX (US)

(72) Inventors: Eric Howard, Lititz, PA (US); Phillip Getto, Dallas, TX (US)

(73) Assignee: ORAMETRIX, INC., Richardson, TX (US)

(21) Appl. No.: 14/696,369

(22) Filed: Apr. 24, 2015

Related U.S. Application Data
(60) Provisional application No. 61/984,049, filed on Apr. 25, 2014.

(51) Int. Cl. A61C 7/00; A61C 7/14; A61C 9/00; A61C 7/08

(52) U.S. Cl. CPC A61C 7/002; A61C 7/08; A61C 7/14; A61C 9/0053

(57) ABSTRACT

The present invention discloses an orthodontic appliance for positioning teeth and its application in orthodontic treatment planning using a work station. 3D teeth models are created from scanning data. These teeth models display a patient's teeth in initial or mal-occlusion. Then an orthodontic treatment planning is performed and the teeth are positioned in a desired position. 3D model of teeth in mal-occlusion is super imposed on the 3D model of the teeth in the desired position. Gingiva obtained from the scanning data is also superimposed on the combination of the 3D mal-occlusion model and the 3D desired position model. The resulting 3D model is used to create a 3D composite physical dentition model using a 3D printing device or a 3D printer. Dimples of the desired shape and position are then placed on the composite physical model. The teeth positioning appliance is then created by molding plastic on the composite physical model. Buttons are created on the plastic device where the dimples are placed on the composite model. The plastic device is then placed on the teeth like an aligner or a retainer. The buttons apply forces on the teeth to move the teeth in the desired position.

### CROSS-REFERENCE TO RELATED APPLICATIONS

This application is a non-provisional application of the provisional application, Ser. No. 61/984,049, filed Apr. 25, 2014. Priority of the filing date of the provisional application is hereby claimed for the instant application.

This application is related to prior application Ser. No. 09/834,412 filed Apr. 13, 2001, now issued as U.S. Pat. No. 6,632,089; and in published OraMetrix patent application WO 01/80761; as well as to prior application Ser. No. 09/835,039 filed Apr. 13, 2001, now issued as U.S. Pat. No. 6,648,640, the contents of each of which are incorporated by reference herein. Priority of these related applications is not claimed.

### BACKGROUND OF THE INVENTION

### A. Field of the Invention

This invention relates generally to the field of orthodontics. More particularly, the invention relates to a tooth positioning appliance for orthodontic treatment of a patient.

### SUMMARY OF THE INVENTION

The present invention discloses an orthodontic appliance for positioning teeth and its application in orthodontic treatment of a patient.

Three dimensional (“3D”) digital or virtual teeth models are created from—data obtained through scanning the dentition of an orthodontic patient. These teeth models display a patient's teeth in an initial stage which may be a mal-occlusion stage or an intermediate stage achieved during the orthodontic treatment process. Then, an orthodontic treatment planning is performed and the teeth are positioned in a desired position, wherein the desired position may be another intermediate stage during the orthodontic treatment or the final stage of the treatment of the patient. 3D digital or virtual model of the teeth in initial stage is super imposed on the 3D digital or virtual model of the teeth in the desired position thereby creating a composit 3D digital or virtual model of the teeth. Gingiva obtained from the scanning data is also digitally superimposed on the combination of the 3D initial model and the 3D desired position model, i.e., the composit 3D digital or virtual model of the teeth. The resulting 3D digital or virtual composit model with gingiva is used to create a 3D composite physical dentition model using a 3D printing device or a 3D printer. Dimples of the desired shape and position are then created on the outer surface of the composite physical dentition model. The dimples create small pockets. These can be created using a dental hand piece, small drill or hand-held mill, like a Dremel tool by removing a small amount of material to make the dimple (pocket). Alternately, the dimples can be created on the composite 3D digital or virtual model of the teeth using the treatment planning workstation; and the 3D composite physical dentition model can be subsequently created using a 3D printing device or a 3D printerin a manner such that the 3D composite physical dentition model will automatically have dimples without requiring the manual process to create those dimples. The tooth positioning appliance is then created by molding plastic on the composite physical model via a vacuum forming process. During the plastic molding process buttons or protrusions are created on the plastic device, i.e., the tooth positioning appliance, corresponding to the dimples created on the composite model. The plastic device is then placed on the teeth like an aligner or a retainer. The buttons face the teeth surface and apply forces on the teeth to move the teeth in the desired position. The forces are designed to cause the desired translational, rotational or a torque movement, or a combination of movements to reposition one or more teeth.

The dimples and corresponding tooth positioning appliance tray protrusions or buttons are important because the physical model consists of the same teeth in two different positions, initial and final, initial and first intermediate stage, two intermediate stages of movement or last intermediate stage and final position. The tooth positioning appliances produced from these composite models often have larger tooth cavities because they allow more movement than a traditional aligner. The model dimples and tooth positioning appliance tray buttons provide a way to exert additional force when much of the tooth positioning appliance tooth cavity walls are not in contact with an individual tooth.

Treatment can be planned to move the teeth in stages. 3D composite physical model can be created again and again to accomplish the movement of teeth at each stage. This is accomplished by creating new dimples on the 3D composite physical model and then molding a corresponding new plastic device for moving the teeth to the next stage as needed.

When creating the dimples on the digital model prior to printing, the physical printed models include the dimples and the manual process of drilling out the dimples is not needed. The tooth positioning appliance tray production remains the same (vacuum forming over the physical model with dimples). Note in this case, software can be used to calculate the intended direction of movement for the stage and the preferred size and placement of the dimple/button to apply the additional tooth moving forces.

In another embodiment of the invention, the combination of the 3D initial dentition model and the 3D desired position dentition model (or the “virtual combination dentition model”) can be used to directly create the tooth positioning appliance using a 3D printing device. In this case the virtual dimples are created on the virtual combination dentition model, which in turn help to create the desired buttons of the tooth positioning appliance during the 3D printing process. As an additional embodiment, software can design the tooth positioning appliance with the buttons and can send the design data to a 3D printer for direct printing the tooth positioning appliance. It should be noted that these embodiments eliminate the intermediate step of creating the 3D composite physical model, saving time and reducing cost.

The tooth positioning appliance is created for treatment of the teeth in a single jaw. Two such appliances are required for treating teeth in both the jaws; one for the upper jaw and the other for the lower jaw.

The tooth positioning appliance described herein is similar to an aligner; and snaps on the teeth when in use. It can be removed when desired, and then re-snapped on the teeth.

The tooth positioning appliance disclosed herein makes it possible to have a hybrid orthodontic treatment for a patient wherein teeth in one jaw are treated with a tooth positioning appliance, and the teeth in the other jaw with a brace comprising a combination of brackets glued to the teeth and an archwire.

### BRIEF DESCRIPTION OF THE DRAWINGS

Presently preferred embodiments of the invention are described below in reference to the appended drawings, wherein like reference numerals refer to like elements in the various views, and in which:

FIG. 1 is block diagram of a system for creating a three-dimensional virtual patient model and for diagnosis and planning treatment of the patient.

FIG. 2 shows 3D model of the teeth in the upper jaw of a patient in mal-occlusion obtained from the scanning data.

FIG. 3 shows 3d model of the teeth in the lower jaw of the patient in mal-occlusion obtained from the scanning data.

FIG. 4 shows 3D model of the teeth in the upper and lower jaws of the patient in mal-occlusion obtained from the scanning data.

FIG. 5 shows another view of the 3D model of the teeth in the lower jaw of the patient in mal-occlusion obtained from the scanning data compared to FIG. 3.

FIG. 6 shows the 3D model of the teeth in the lower jaw of the patient placed in the desired position or set-up through the orthodontic treatment planning.

FIG. 7 shows the 3D model of FIG. 6 superimposed over the 3D model of FIG. 5.

FIG. 8 shows the 3D model of FIG. 7 with gingiva.

FIG. 9 shows the 3D composite model created by a 3D printing apparatus from the 3D model of FIG. 8.

FIG. 10 shows the 3D composite model of FIG. 9 with dimples created at the desired positions and of the desired size.

FIG. 11 shows the front view of the 3D composite model of FIG. 9.

FIG. 12 shows the plastic tooth positioning appliance molded form the the 3D composite model of FIG. 10.

FIG. 13 shows yet another view of the plastic tooth positioning appliance of FIG. 12 with buttons.

FIG. 14 shows 3D model of the teeth in the upper and lower jaws of the patient in mal-occlusion with teeth roots obtained from the surface scanning data and the CT volume scan data.

FIG. 15 shows 3D model of the teeth in the upper jaw with brackets mounted on the teeth for orthodontic treatment using archwire, which is not shown in the figure.

### DETAILED DESCRIPTION OF PREFERRED EMBODIMENT

Before describing the features of this invention in detail, an overview of a unified workstation will be set forth initially. The workstation provides software instructions that enable creation of two dimensional and/or three dimensional virtual patient models on a computer, which can be used for purposes of communication, diagnosis, treatment planning and design of customized appliances in accordance with a presently preferred embodiment.

The essence of the invention disclosed herein is the ability to capture images from various sources that provide volumetric images, surface images that are 3D or two dimensional (“2D”) in nature, and may be static or dynamic, such as from CBCT, CAT, MRI, fMRI, ultrasound device, cameras that provide still photos, white light and laser based surface scanners, video cameras providing video images, tracking devices and digital camera. Images from these sources are combined as needed to create a unified simulation model of the craniofacial and dental facial complex, to facilitate diagnosis, communication, planning treatment and design of appliances for treating craniofacial and dento facial problems. With these images a composite structure of the face can be constructed with dynamic or static behavioral properties. One can also track function or jaw movement and simulate the functional movements, e.g., smile movement of the lower jaw etc.

The global positioning of the entire face with respect to its surroundings can be set by the user for planning purposes. In addition, the relative position of each of the structural elements, such as the upper jaw and its teeth when captured independently can be oriented with respect to any other structure such as the soft tissue face by using specific anatomical land marks or user defined reference planes, either in 2D or 3D space. Furthermore, the relationship of the lower jaw and its accompanying teeth can be registered with respect to the upper jaw using a combination of registration techniques. For instance, the bite registration can be recorded by taking an intraoral surface scan of the teeth together and using it as a template to register the relationship of the upper jaw and the lower jaw from a CBCT volumetric scan.

Most importantly from volumetric data, one can extract three dimensional structural data which may include crowns and roots of teeth, bone, soft tissue, e.g., gingiva and facial soft tissue and appliances attached to any of these structures, such as orthodontic brackets, implants, etc. Each of these structural elements can be independently manipulated in three dimensional space to construct a treatment plan, and design the appropriate device for correction of a problem. Furthermore, the interdependencies of the treatment between these various structural components can be modeled to design a holistic treatment plan. Specific relationships between the various structural components can be defined by choosing an appropriate reference plane and capturing the spatial relationships between specific structures. The treatment design may include repositioning, restoring, replacing of any of the structural elements in 2D or 3D space. Also function can be simulated or modeled based upon captured data to achieve the desired goals, e.g., the teeth with their roots can be appropriately positioned in the bone to withstand the stresses of jaw movement or the position of the jaw joint i.e. the condyle is in harmony with the position of the teeth to prevent any source of dysfunction or breakdown of the structural elements. Mechanical analysis, such as finite element method, may also be used to better understand the nature of stresses and strains imposed on the structural elements to design better treatment. All changes may be measured with respect to defined planes of reference to provide numerical output to design a variety of customized treatment devices, such as orthodontic brackets, orthodontic archwires, surgical bite splints, surgical fixation plates, implants, condylar prosthesis, bone screws, periodontal stents, mouth guards, bite plates, removable orthodontic appliances, crowns, bridges, dentures, partial dentures, obturataors, temporary anchorage devices from either natural or synthetic substances using printing devices, such as SLA or milling or robotic manufacturing. Any type of dental, orthodontic, restorative, prosthodontic or surgical device which may be tissue borne, dental borne, osseous borne, can be designed in combination, or singularly in serial or in parallel, e.g., indirect bonding trays that allow bonding of brackets, and are also designed to guide implant insertion. Furthermore, if the patient requires surgery, splints, fixation plates, boney screws may all be designed and manufactured simultaneously. The numerical output of the treatment plan can be used to drive navigational systems for performing any procedure. Simulations can be used to train and build skills or examine proficiency. The numerical output of the treatment design can be used to drive robots to perform surgical procedures. Furthermore this output can be used to create a solid model representation of the treatment plan using printing or milling techniques.

Template data or normative data stored in memory can be used to plan any of the structural changes or design of the devices. In addition, reference data from the non-affected structural elements may be used as templates to provide design parameters to plan and correct the affected side.

One can also replace or remove any of the structures to achieve the desired goal, e.g., extraction of teeth, root amputation, sinus lift, veneers, inter-proximal reduction, etc. The codependency of movement of one object and its effect on another can also be simulated for all three tissue types, e.g., when the tooth moves how does it affect the gum soft tissue when the tooth moves where does the root move in reference to the bone or how does the bone change how does the face change when the bones move. All types of planning can be executed by different modalities or professionals in an interactive manner asynchronously or synchronously.

In summary, the invention disclosed herein provides the ability to plan crowns with roots thereby optimizing the planning by changing the root position so that the crown planned is designed such that axial forces are transmitted to the roots to add to the stability of the crown minimizing aberrant forces that can lead to root fracture, crown fracture, and breakdown of the periodontium or bone. Similarly for surgical patients one can plan root positions so that the surgeon can cut between the roots and prevent damage besides planning the movement of the bones. Similarly for implants one can move the roots in a desirable location so that the implant when inserted doesn't damage the roots. The user can also size the implants correctly so that they don't encroach on root space. All this planning would be impossible if the roots were not made separate objects that could move. Finally one can move the roots preferentially to create bone. As one extrudes a root one can create bone. Similarly one can change the gum tissue architecture by moving roots and for orthodontic movement one can avoid moving roots where there is no bone or selectively move teeth to prevent root collision or move roots away from areas where there is lack of bone into where there is as one plans to move them towards their final destination. Again not only can one plan tooth movement but bone movement and soft tissue gum and face as well to achieve the goals. One can alter the spatial position of all the objects which are extracted, change their shape form and volume to restore and or reconstruct. One can sculpt or remove selectively any region gum soft issue bone dentition. Although one can use a fusion technique, the preferred embodiment is to extract the data from the CBCT for bone and dentition with roots at a minimum. One can take partial in-vitro scans where distortion is expected, e.g., large metal crowns or fillings or one can scan an impression in those areas or plaster limited to the region of interest.

The images of the roots can be taken with CBCT and affixed to crowns taken by scanning in-vitro impressions or models. The preferred process does not require fusing a model of the dentition into the cranio-facial structure. All needed information can be captured in one shot and extract individual features. The invention disclosed herein captures the dental and osseous and soft tissue as one and segregate them in to individual components for planning treatment. The optimization of the treatment plan can be achieved by using different approaches, e. g., correcting crowding by minimizing tooth movement and planning veneers or minimizing tooth preparation for veneer construction by positioning the teeth appropriately. This can be said for any structure and the decision can be driven by the patients need, time constraints, cost risk benefit, skill of operator, etc.

Many of the details and computer user interface tools which a practitioner may use in adjusting tooth position, designing appliance shape and location, managing space between teeth, and arriving at a finish tooth position using interaction with a computer storing and displaying a virtual model of teeth are set forth in the prior application Ser. No. 09/834,412 filed Apr. 13, 2001, and in published OraMetrix patent application WO 01/80761, the contents of which are incorporated by reference herein. Other suites of tools and functions are possible and within the scope of the invention. Such details will therefore be omitted from the present discussion.

### General Description

A unified workstation environment and computer system for diagnosis, treatment planning and delivery of therapeutics, especially adapted for treatment of craniofacial structures, is described below. In one possible example, the system is particularly useful in diagnosis and planning treatment of an orthodontic patient. Persons skilled in the art will understand that the invention, in its broader aspects, is applicable to other craniofacial disorders or conditions requiring surgery, prosthodontic treatment, restorative treatment, etc.

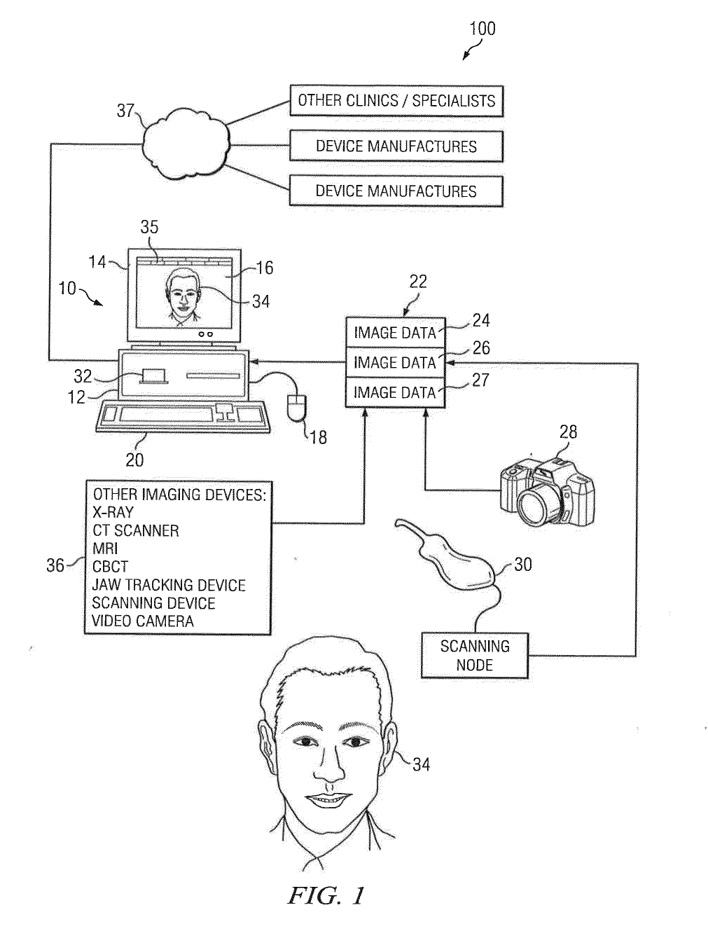

A presently preferred embodiment is depicted in FIG. 1. The overall system 100 includes a general-purpose computer system 10 having a processor (CPU 12) and a user interface 14, including screen display 16, mouse 18 and keyboard 20. The system is useful for planning treatment for a patient 34.

The system 100 includes a computer storage medium or memory 22 accessible to the general-purpose computer system 10. The memory 22, such as a hard disk memory or attached peripheral devices, stores two or more sets of digital data representing patient craniofacial image information. These sets include at least a first set of digital data 24 representing patient craniofacial image information obtained from a first imaging device and a second set of digital data 26 representing patient craniofacial image information obtained from a second image device different from the first image device. The first and second sets of data represent, at least in part, common craniofacial anatomical structures of the patient. At least one of the first and second sets of digital data normally would include data representing the external visual appearance or surface configuration of the face of the patient.

In a representative and non-limiting example of the data sets, the first data set 24 could be a set of two dimensional color photographs of the face and head of the patient obtained via a color digital camera 28, and the second data set is three-dimensional image information of the patient's teeth, acquired via a suitable scanner 30, such as a hand-held optical 3D scanner, or other type of scanner. The memory 22 may also store other sets 27 of digital image data, including digitized X-rays, MRI or ultrasound images, CT scanner, CBCT scanner, jaw tracking device, scanning device, video camera, etc., from other imaging devices 36. The other imaging devices need not be located at the location or site of the workstation system 100. Rather, the imaging of the patient 34 with one or other imaging devices 36 could be performed in a remotely located clinic or hospital, in which case the image data is obtained by the workstation 100 over the Internet 37 or some other communications medium, and stored in the memory 22.

The system 100 further includes a set of computer instructions stored on a machine-readable storage medium. The instructions may be stored in the memory 22 accessible to the general-purpose computer system 10. The machine-readable medium storing the instructions may alternatively be a hard disk memory 32 for the computer system 10, external memory devices, or may be resident on a file server on a network connected to the computer system, the details of which are not important. The set of instructions, described in more detail below, comprise instructions for causing the general computer system 10 to perform several functions related to the generation and use of the virtual patient model in diagnostics, therapeutics and treatment planning

These functions include a function of automatically, and/or with the aid of operator interaction via the user interface 14, superimposing the first set 24 of digital data and the second set 26 of digital data so as to provide a composite, combined digital representation of the craniofacial anatomical structures in a common coordinate system. This composite, combined digital representation is referred to herein occasionally as the “virtual patient model,” shown on the display 16 of FIG. 1 as a digital model of the patient 34. Preferably, one of the sets 24, 26 of data includes photographic image data of the patient's face, teeth and head, obtained with the color digital camera 28. The other set of data could be intra-oral 3D scan data obtained from the hand-held scanner 30, CT scan data, X-Ray data, MRI, etc. In the example of FIG. 1, the hand-held scanner 30 acquires a series of images containing 3D information and this information is used to generate a 3D model in the scanning node 31, in accordance with the teachings of the published PCT application of OraMetrix, PCT publication no. WO 01/80761, the contents of which are incorporated by reference herein. Additional data sets are possible, and may be preferred in most embodiments. For example the virtual patient model could be created by a superposition of the following data sets: intra-oral scan of the patient's teeth, gums, and associated tissues, X-Ray, CT scan, intra-oral color photographs of the teeth to add true color (texture) to the 3D teeth models, and color photographs of the face, that are combined in the computer to form a 3D morphable face model. These data sets are superimposed with each other, with appropriate scaling as necessary to place them in registry with each other and at the same scale. The resulting representation can be stored as a 3D point cloud representing not only the surface on the patient but also interior structures, such as tooth roots, bone, and other structures. In one possible embodiment, the hand-held in-vivo scanning device is used which also incorporates a color CCD camera to capture either individual images or video.

The software instructions further includes a set of functions or routines that cause the user interface 16 to display the composite, combined digital three-dimensional representation of craniofacial anatomical structures to a user of the system. In a representative embodiment, computer-aided design (CAD)-type software tools are used to display the model to the user and provide the user with tools for viewing and studying the model. Preferably, the model is cable of being viewed in any orientation. Tools are provided for showing slices or sections through the model at arbitrary, user defined planes. Alternatively, the composite digital representation may be printed out on a printer or otherwise provided to the user in a visual form.

The software instructions further include instructions that, when executed, provide the user with tools on the user interface 14 for visually studying, on the user interface, the interaction of the craniofacial anatomical structures and their relationship to the external, visual appearance of the patient. For example, the tools include tools for simulating changes in the anatomical position or shape of the craniofacial anatomical structures, e.g., teeth, jaw, bone or soft tissue structure, and their effect on the external, visual appearance of the patient. The preferred aspects of the software tools include tools for manipulating various parameters such as the age of the patient; the position, orientation, color and texture of the teeth; reflectivity and ambient conditions of light and its effect on visual appearance. The elements of the craniofacial and dental complex can be analyzed quickly in either static format (i.e., no movement of the anatomical structures relative to each other) or in a dynamic format (i.e., during movement of anatomical structures relative to each other, such as chewing, occlusion, growth, etc.). To facilitate such modeling and simulations, teeth may be modeled as independent, individually moveable 3 dimensional virtual object, using the techniques described in the above-referenced OraMetrix published PCT application, WO 01/80761.

The workstation environment provided by this invention provides a powerful system and for purposes of diagnosis, treatment planning and delivery of therapeutics. For example, the effect of jaw and skull movement on the patient's face and smile can be studied. Similarly, the model can be manipulated to arrive at the patient's desired feature and smile. From this model, and more particularly, from the location and position of individual anatomical structures (e.g., individual tooth positions and orientation, shape of arch and position of upper and lower arches relative to each other), it is possible to automatically back solve for or derive the jaw, tooth, bone and/or soft tissue corrections that must be applied to the patient's initial, pre-treatment position to provide the desired result. This leads directly to a patient treatment plan.

These simulation tools, in a preferred embodiment, comprise user-friendly and intuitive icons 35 that are activated by a mouse or keyboard on the user interface of the computer system 10. When these icons are activated, the software instruction provide pop-up, menu, or other types screens that enable a user to navigate through particular tasks to highlight and select individual anatomical features, change their positions relative to other structures, and simulate movement of the jaws (chewing or occlusion). Examples of the types of navigational tools, icons and treatment planning tools for a computer user interface that may be useful in this process and provide a point of departure for further types of displays useful in this invention are described in the patent application of Rudger Rubbert et al., Ser. No. 09/835,039 filed Apr. 13, 2001, now issued as U.S. Pat. No. 6,648,640, the contents of which are incorporated by reference herein. The virtual patient model, or some portion thereof, such as data describing a three-dimensional model of the teeth in initial and target or treatment positions, is useful information for generating customized orthodontic appliances for treatment of the patient. The position of the teeth in the initial and desired positions can be used to generate a set of customized brackets, and customized flat planar archwire, and customized bracket placement jigs, as described in the above-referenced Andreiko et al. patents. Alternatively, the initial and final tooth positions can be used to derive data sets representing intermediate tooth positions, which are used to fabricate transparent aligning shells for moving teeth to the final position, as described in the above-referenced Chisti et al. patents. The data can also be used to place brackets and design a customized archwire as described in the previously cited application Ser. No. 09/835,039.

To facilitate sharing of the virtual patient model among specialists and device manufacturers, the system 100 includes software routines and appropriate hardware devices for transmitting the virtual patient model or some subset thereof over a computer network. The system's software instructions are preferably integrated with a patient management program having a scheduling feature for scheduling appointments for the patient. The patient management program provides a flexible scheduling of patient appointments based on progress of treatment of the craniofacial anatomical structures. The progress of treatment can be quantified. The progress of treatment can be monitored by periodically obtaining updated three-dimensional information regarding the progress of treatment of the craniofacial features of the patient, such as by obtaining updated scans of the patient and comparison of the resulting 3D model with the original 3D model of the patient prior to initiation of treatment.

Thus, it is contemplated that system described herein provides a set of tools and data acquisition and processing subsystems that together provides a flexible, open platform or portal to a variety of possible therapies and treatment modalities, depending on the preference of the patient and the practitioner. For example, a practitioner viewing the model and using the treatment planning tools may determine that a patient may benefit from a combination of customized orthodontic brackets and wires and removable aligning devices. Data from the virtual patient models is provided to diverse manufacturers for coordinated preparation of customized appliances. Moreover, the virtual patient model and powerful tools described herein provide a means by which the complete picture of the patient can be shared with other specialists (e.g., dentists, maxilla-facial or oral surgeons, cosmetic surgeons, other orthodontists) greatly enhancing the ability of diverse specialists to coordinate and apply a diverse range of treatments to achieve a desired outcome for the patient. In particular, the overlay or superposition of a variety of image information, including 2D X-Ray, 3D teeth image data, photographic data, CT scan data, and other data, and the ability to toggle back and forth between these views and simulate changes in position or shape of craniofacial structures, and the ability to share this virtual patient model across existing computer networks to other specialists and device manufacturers, allows the entire treatment of the patient to be simulated and modeled in a computer. Furthermore, the expected results can be displayed beforehand to the patient and changes made depending on the patient input.

With the above general description in mind, the novel tooth positioning appliance will be described next.

The present invention discloses a tooth positioning appliance for use in orthodontic treatment of a patient and a method of designing and making the appliance.

The tooth positioning appliance comprises an apparatus made from plastic that is placed on the teeth in a jaw of a patient for repositioning the teeth during an orthodontic treatment. The appliance has active buttons or protrusions, facing the tooth surface, that apply the force on the corresponding tooth to gradually reposition the tooth in the desired position. The buttons are shaped to exert the desired force. The force may be for lateral movement, rotation or torque or a desired combination of these forces. The buttons are placed in labial or lingual positions on the appliance per the treatment plan. In a single appliance the buttons may be positioned on the lingual side alone, or the labial side alone, or on both the lingual as well as the labial sides. Undercuts were filled with pink Triad. It is also possible to fill undercuts or the valleys between the corresponding teeth features via software with known techniques, commonly found in commercial CAD software, such as swept volumes. The tooth positioning appliance, although similar to an aligner, represents a significant change in methodology and has the potential to extend the scope of what's possible with the tooth positioning appliance. What makes this possible is the ability to print the double-image model of teeth in their starting position and the treatment goal, and the technique to develop the force system to propel the tooth. Attachments on teeth can additionally be used to engage the dimple in the tooth positioning appliance. The method of designing and fabricating the tooth positioning appliance will be described next.

This embodiment discloses one method of designing and making the tooth positioning appliance. The method is carried out using the workstation.

Step 1. A digital or virtual 3D dentition model of a patient is created from the data obtained by scanning the teeth of the patient in a jaw in an initial stage, herein after referred to as the initial dentition mode. The jaw can be the upper jaw or the lower jaw. The initial stage may be the mal-occlusion stage and display the patient's teeth in mal-occlusion.

Step 2. Then, an orthodontic treatment planning is performed on the initial dentition model and the teeth are positioned in a desired position, thereby creating the desired dentition model in 3D, again in the digital or virtual format. Thi desired dentition model may be the model where the teeth are placed in the final position, or the final dentition model.

Step 3. Next, the initial dentition model is super imposed on the 3D model of the teeth in the desired position or the desired dentition model, there by creating a combination model, in 3D digital or virtual format.

Step 4. Gingiva obtained from the scanning data is also superimposed on the combination model of the 3D mal-occlusion model and the 3D desired position model. This model is referred to as the combination model with gingiva.

Step 5. Dimples of the desired shape and position are then placed on the combination model with gingiva.

Step 6. The combination model with gingiva, is then used to create a 3D composite physical dentition model using a 3D printing device or a 3D printer.

Step 7. In the process of creating the 3D composite physical dentition model dimples of the desired shape and position get placed on the composite physical dentition model.

Step 8. Finally, the tooth positioning appliance is created by molding plastic on the composite physical dentition model. Buttons of the size and shape are automatically created on the plastic device where the dimples are placed on the composite physical dentition model.

For the orthodontic treatment, the plastic device, i.e., the tooth positioning appliance is then placed on the teeth in the jaw like an aligner or a retainer. The buttons apply forces on the teeth to move the teeth in the desired position.

Similarly, the tooth positioning appliance can be created for the teeth in the second jaw. If the first jaw is upper, then the second jaw is lower; or viceversa.

Some variations of the above described method are possible. For example, Step 5 can be removed from the method; and in Step 6, the dimples can be created manually on the composite physical dentition model.

The invention disclosed herein is not limited to just using pairs of initial and final models. Obviously that is preferred when possible, but sometimes the amount of tooth movement will require one or more intermediate stages and then the combined models will be defined as pairs of sequential stages beginning with the initial and first intermediate models and continuing to the last intermediate and final models.

Preferably, the teeth are scanned in-vivo using a white light scanner. However, they can also be scanned by any other scanning device.

A wax bite is used to register the two independent jaws with each other based on tooth models made from other scan data. In other words, it provides information on how to position one jaw with respect to the other which is needed if independent scans of each arch is taken and no scan of the arches (jaws) is taken while in occlusion.

Treatment can be planned to move the teeth in stages. One 3D composite physical model can be created from the combination model with gingiva created from the mal-occlusal initial model and the final dentition model based on the treatment planning; and used again and again with enlarging dimples to accomplish the movement of teeth at each stage. This is accomplished by modifying dimples to the desired shape on the 3D composite physical model and then molding a corresponding new plastic device for the tooth positioning appliance with buttons corresponding to the enlarged dimples for moving the teeth to the next stage as needed.

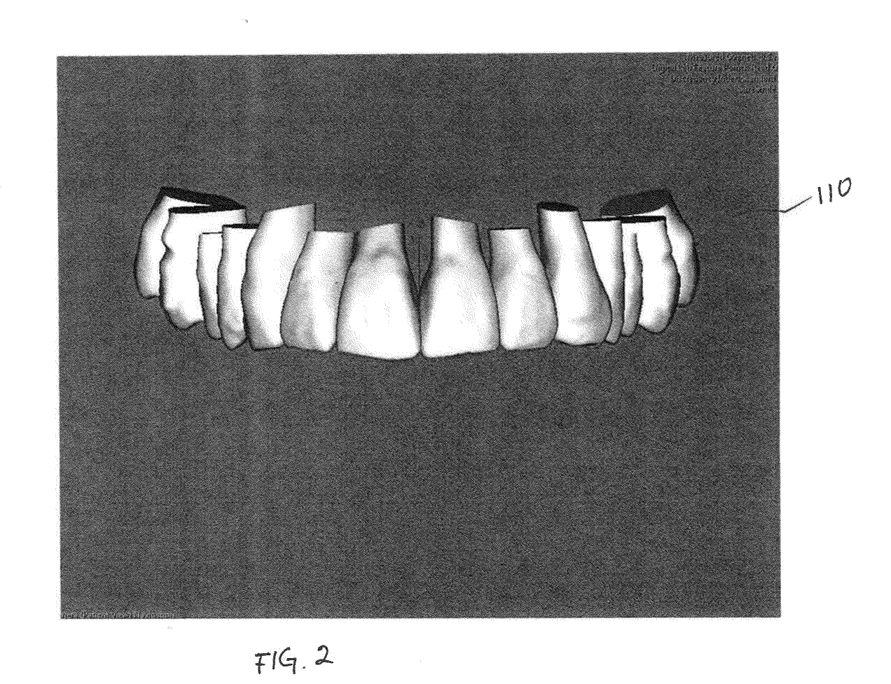

FIG. 2 shows 3D model of the teeth 110 in the upper jaw of a patient in mal-occlusion obtained from the scanning data.

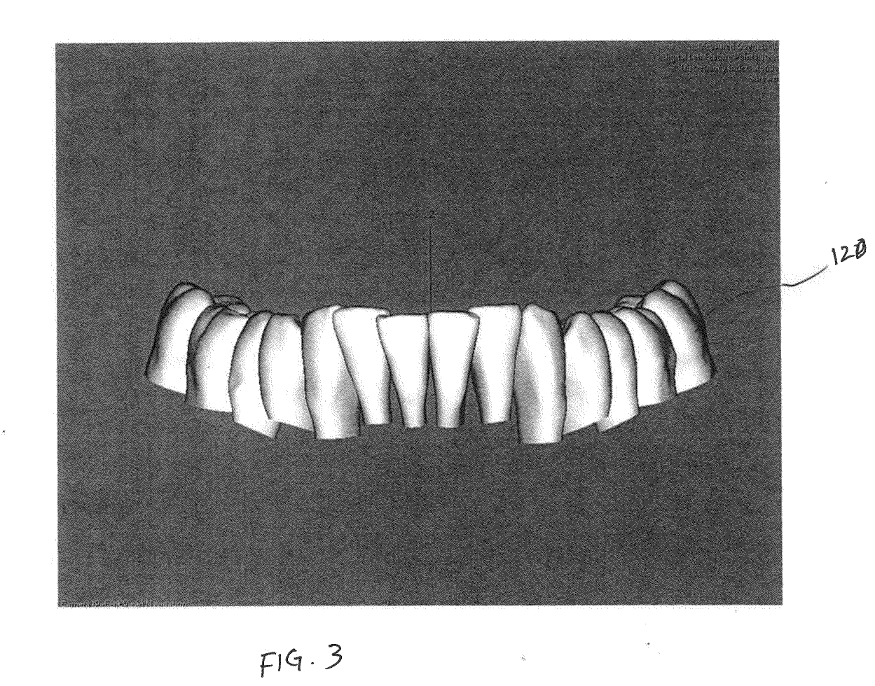

FIG. 3 shows 3D model of the teeth 120 in the lower jaw of the patient in mal-occlusion obtained from the scanning data.

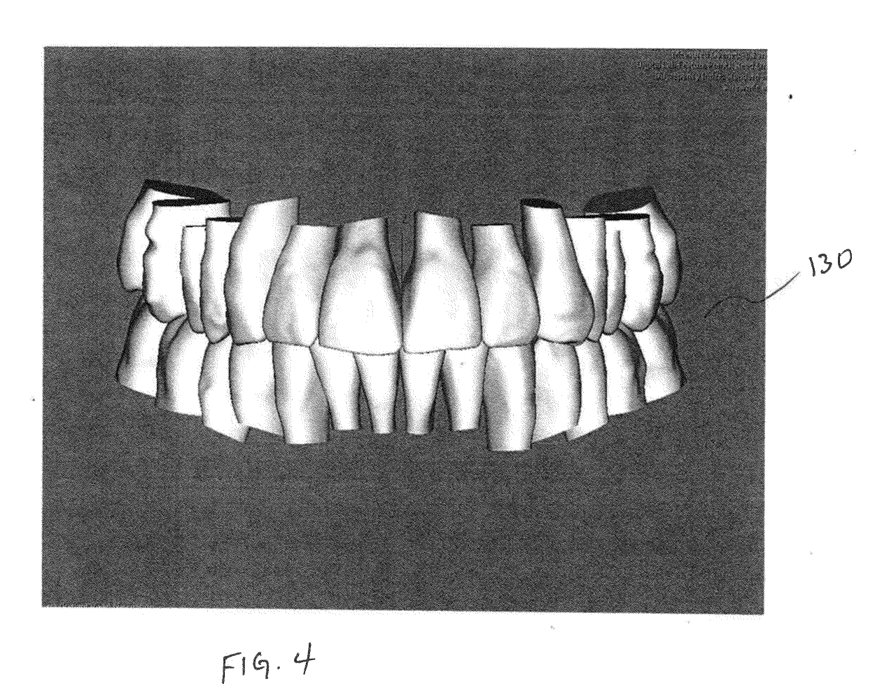

FIG. 4 shows 3D model of the teeth 130 in the upper and lower jaws of the patient in mal-occlusion obtained from the scanning data.

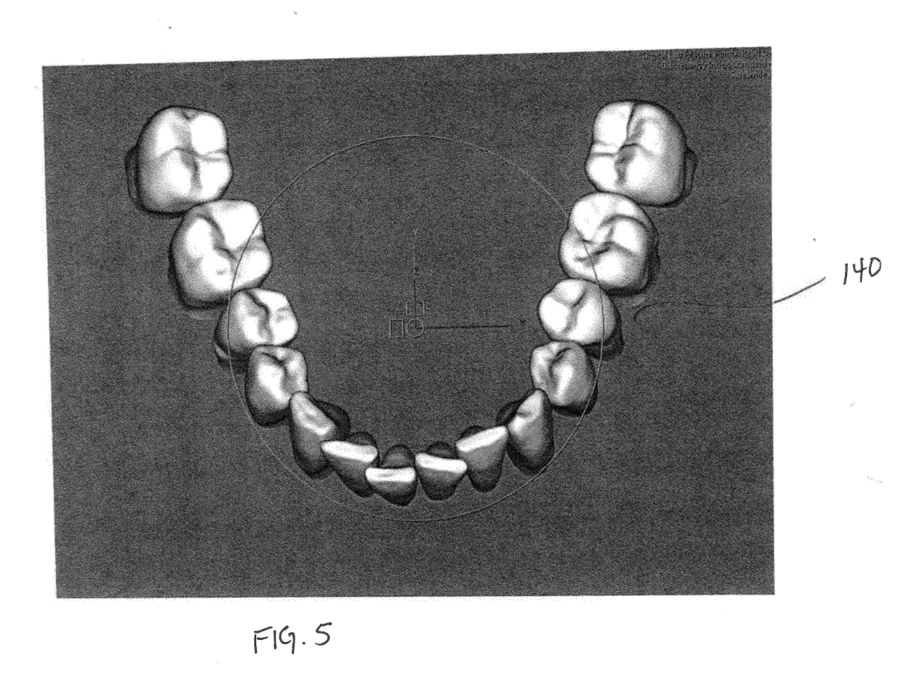

FIG. 5 shows another view of the 3D model of the teeth 140 in the lower jaw, compared to the teeth 120 shown in FIG. 3, of the patient in mal-occlusion state. Both figures are obtained from the same scanning data.

As described above, the surface scanning data for a patient's teeth can be obtained by in-vivo scanning of the teeth or by any other method.

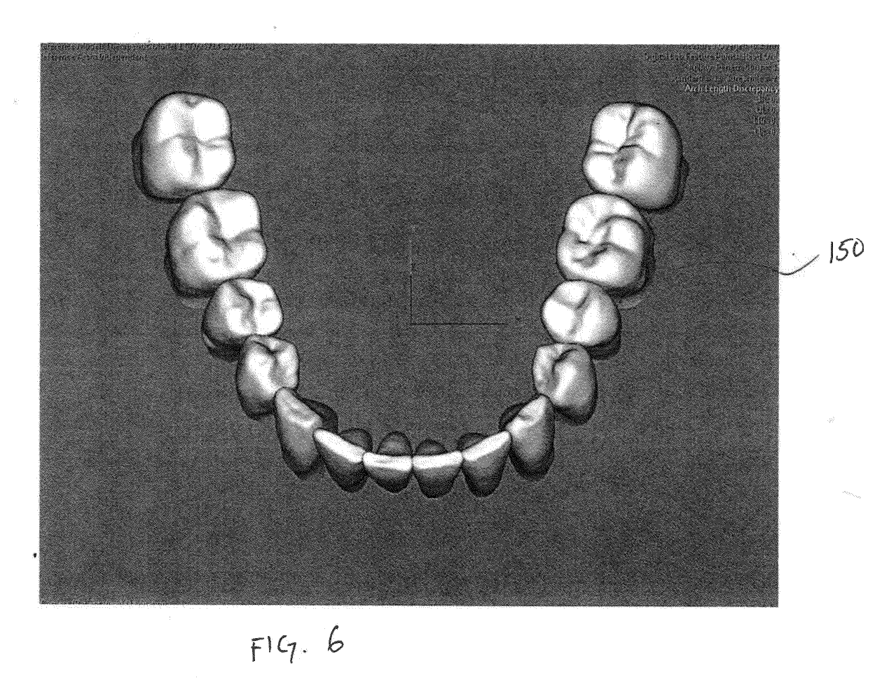

FIG. 6 shows the 3D model of the teeth 150 in the lower jaw of the patient placed in the desired position or set-up through the orthodontic treatment planning The workstation described earlier provides software that can be used to plan the orthodontic treatment in order to cure the mal-occlusion. The teeth can be moved to the desired position or a set-up in one stage or through one or more intermediate stages.

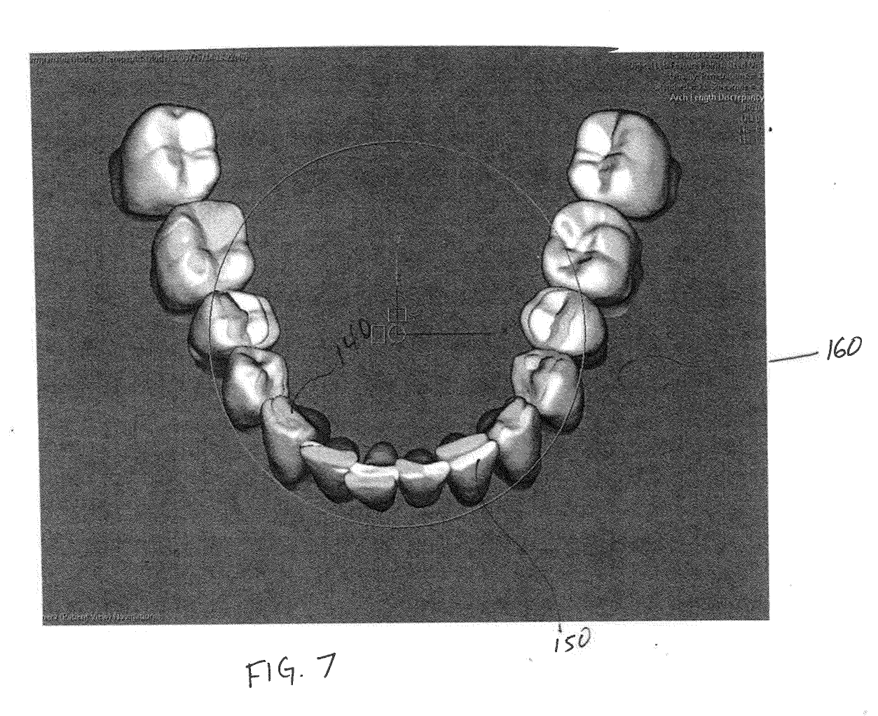

FIG. 7 shows the 3D model 150 of FIG. 6 superimposed over the 3D model 140 of FIG. 5, resulting in a “double-printed” combination model 160.

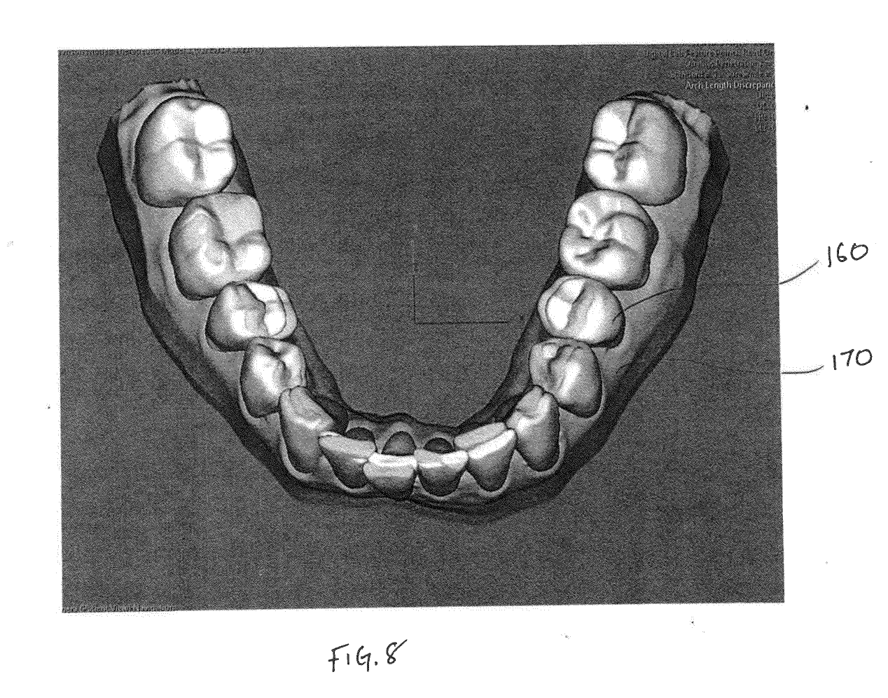

FIG. 8 shows the 3D model 160 of FIG. 7 with gingiva 170. Gingiva model was also obtained during the teeth scanning process.

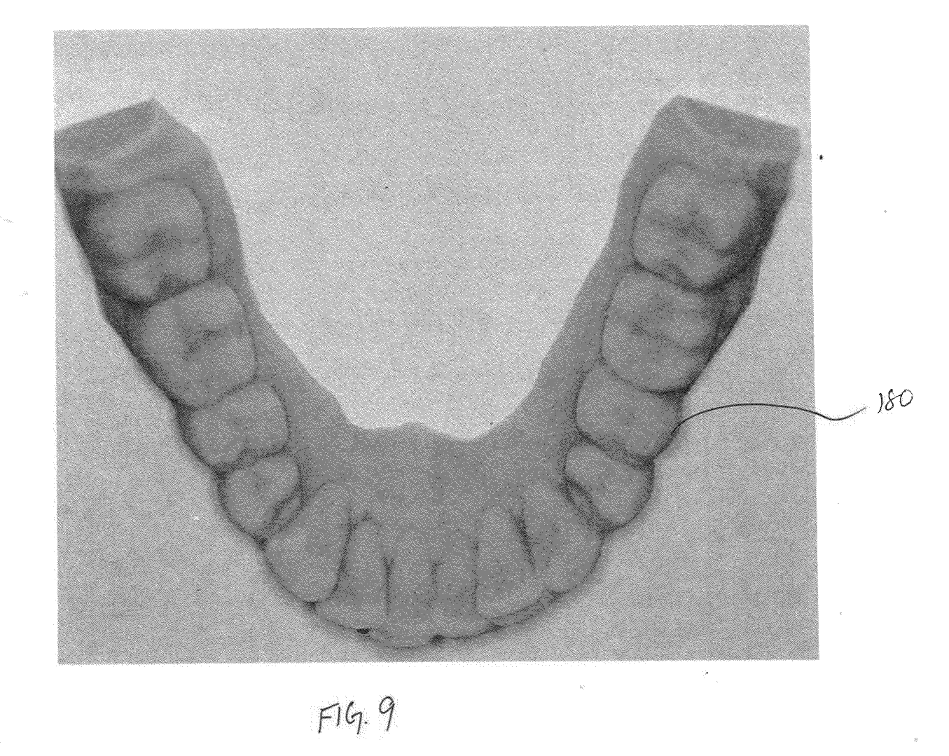

FIG. 9 shows the 3D composite model 180 created using a 3D printing apparatus from the 3D model of FIG. 8.

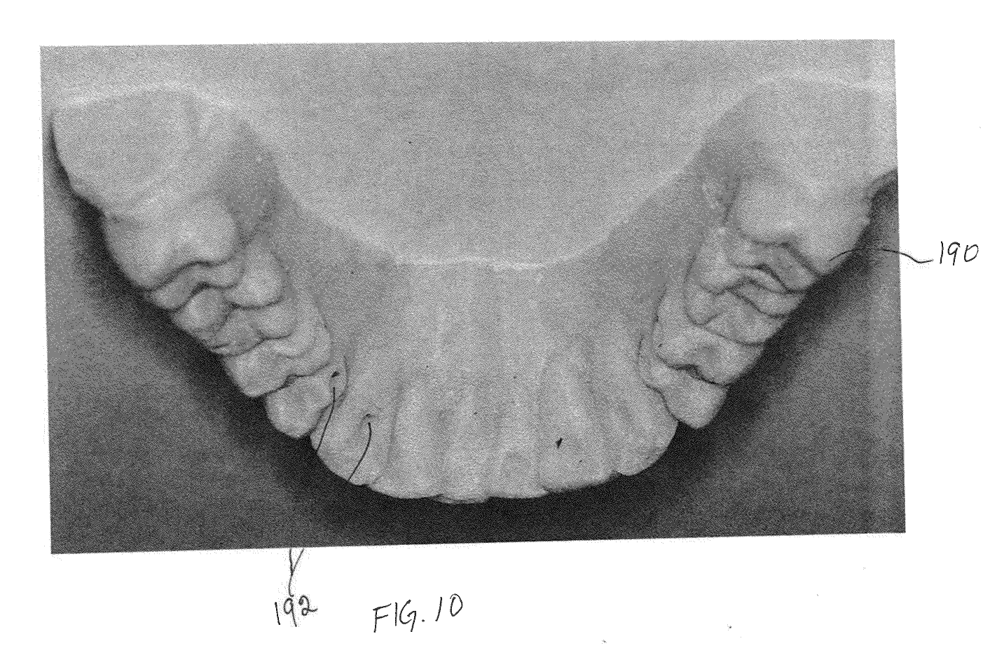

FIG. 10 shows the 3D composite model 190 with dimples 192 created at the desired positions and of the desired size on the model 180 of FIG. 9. The placement of the dimples can be varied depending upon the movement of the corresponding teeth required per the treatment plan.

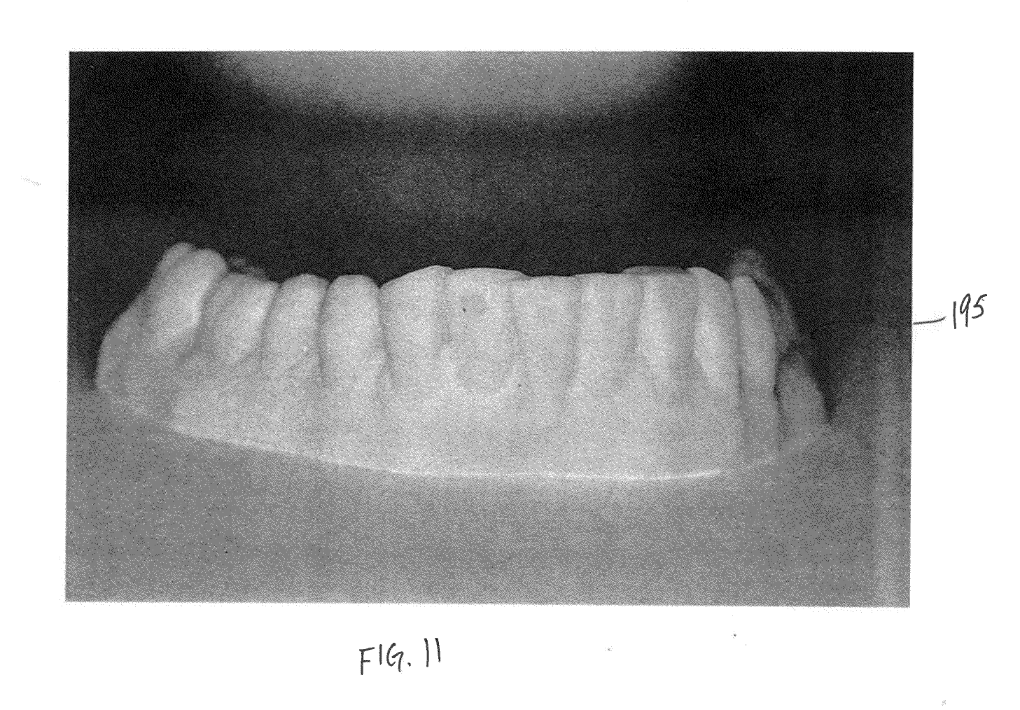

FIG. 11 shows the front view 195 of the 3D composite model 180 of FIG. 9.

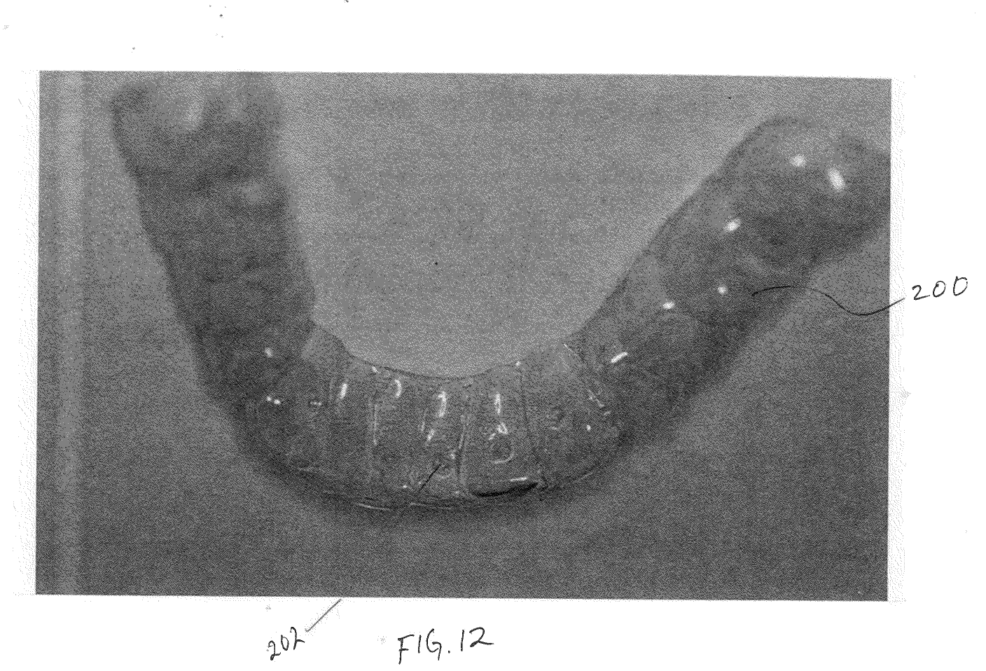

FIG. 12 shows the plastic tooth positioning appliance molded 200 created using the 3D composite model 190 of FIG. 10. FIG. 12 shows buttons 202 corresponding to the dimples 192 placed on the composite model 190 of FIG. 10.

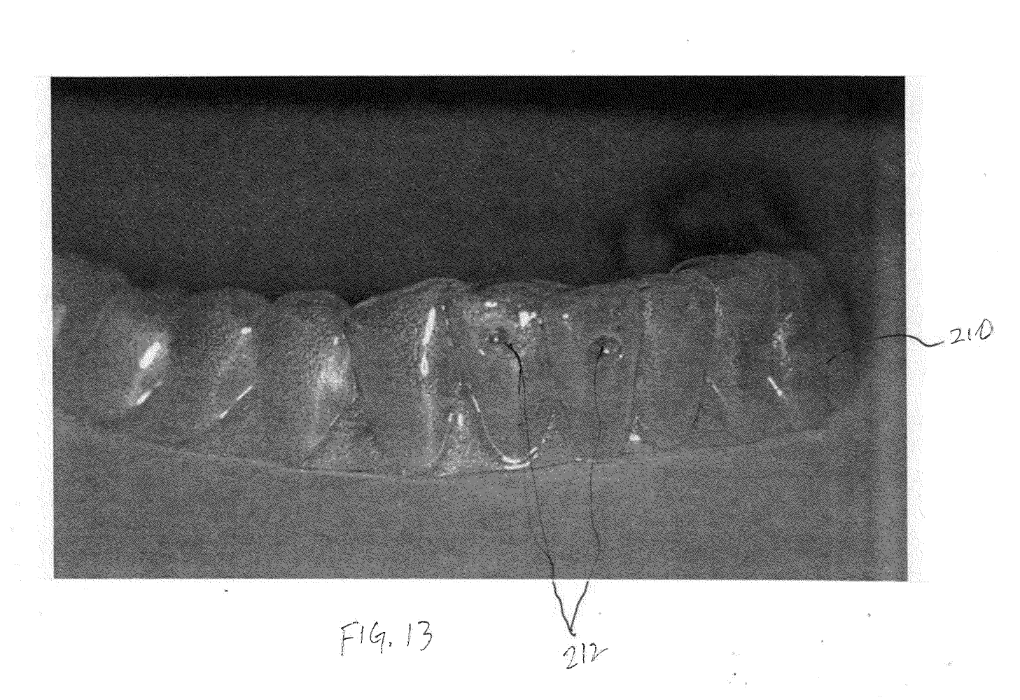

FIG. 13 shows yet another 210 view of the plastic tooth positioning appliance of FIG. 12 with buttons 212 in FIG. 13.

These buttons exert the desired one or more forces on the teeth to gradually move them in the positions desired through the use of the particular plastic tooth positioning appliance.

The plastic tooth positioning appliance is created by placing plastic over the composite model and applying heat through Thermo Air machine to create the desired shape.

Alternately, the dimple/button position can be marked manually; and created through appropriate squeezing of the plastic tooth positioning appliance tray.

In additions to the buttons, some attachments can be additionally placed in the tooth positioning appliance to realize more effective force in moving the teeth.

Although the procedure described above requires creation of the composite physical model for molding the plastic tooth positioning appliance; it is possible to produce the plastic tooth positioning appliance via 3D printing directly from the 3D composite dentitional model with gingiva of FIG. 8; thus eliminating the step of creating the 3D composite physical model, i.e., Steps 6 and 7 can be eliminated.

The tooth positioning appliance described herein is similar to an aligner; and snaps on the teeth when in use. It can be removed when desired, and then re-snapped on the teeth. This appliance can apply one or more desired rotational and translational forces and torque to move the teeth.

The tooth positioning appliance disclosed herein can be made from plastic or other similar material.

The tooth positioning appliance disclosed herein provides improved force and is much cheaper to produce compared to other similar appliances. It significantly shortens the treatment time compared to other similar appliances.

The tooth positioning appliance disclosed herein can be manufactured using a vacuum forming device or a Thermo Air machine.

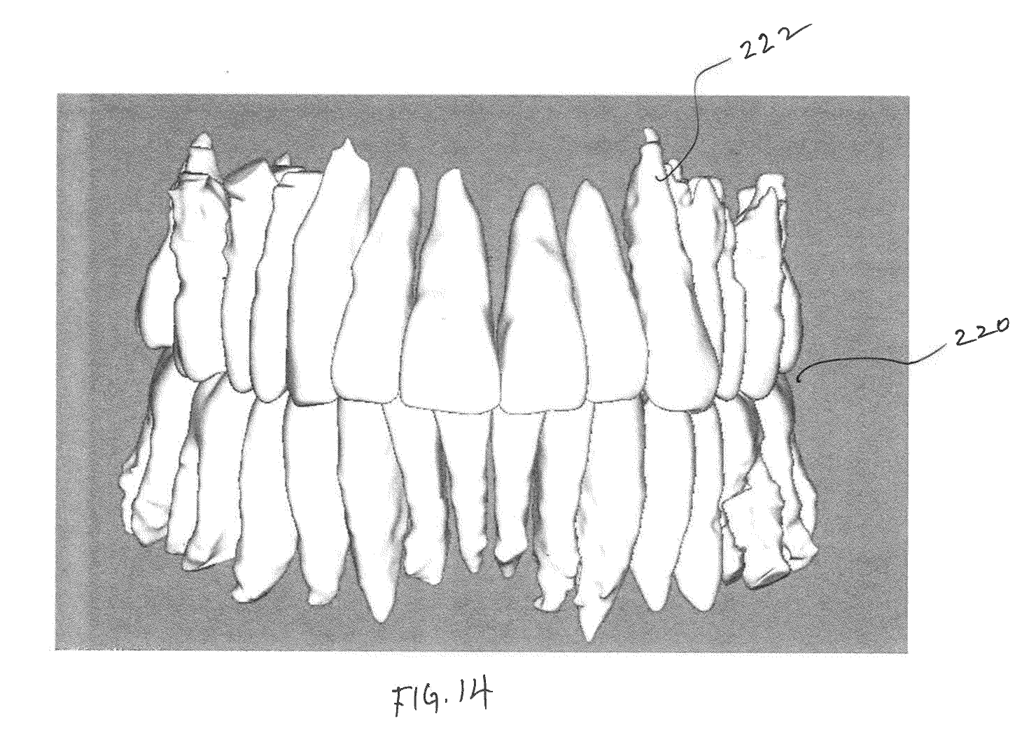

FIG. 14 shows 3D model of the teeth in the upper and lower jaws of the patient in mal-occlusion with teeth roots obtained from the surface scanning data and the CT volume scan data. Information on roots is very important in proper orthodontic treatment planning that avoids potential root collisions.

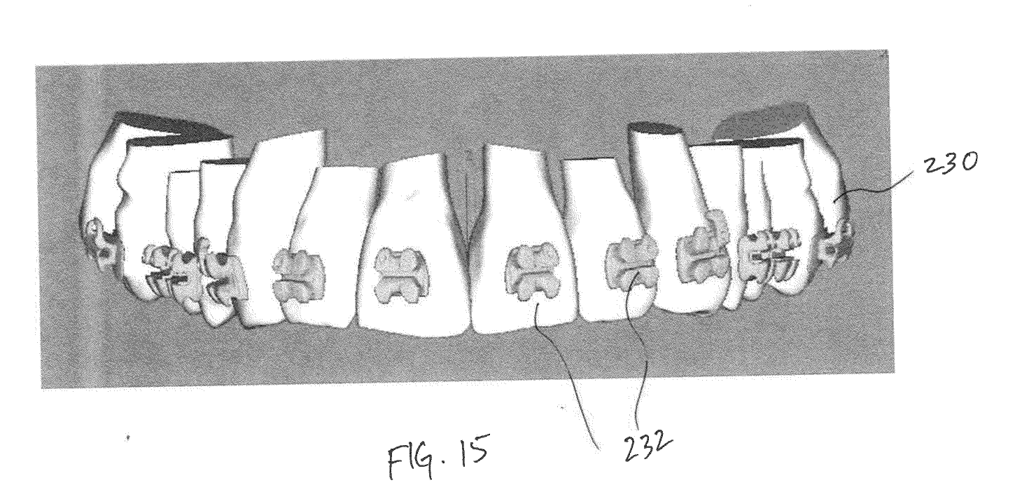

As noted earlier, the tooth positioning device described above can be designed to move the teeth in the lower jaw; and a similar procedure can be used to design the device for the upper jaw as well if called by the treatment plan. On the other hand, if a hybrid treatment plan is more suitable for a patient, then the teeth in one jaw can be treated with the tooth positioning device described above; whereas the teeth in the other jaw can be treated with the brackets and archwire, preferably a customized archwire, as shown in FIG. 15.

FIG. 15 shows 3D model of the teeth 230 in the upper jaw with brackets 232 mounted on the teeth for orthodontic treatment using archwire, which is not shown in the figure.

The orthodontic treatment planning software in the workstation described earlier provides instructions for designing such a hybrid treatment plan as well.

The invention disclosed above for an orthodontic appliance for positioning teeth in orthodontic treatment of a patient is summarized below.

Three dimensional (“3D”) digital or virtual teeth models are created from—data obtained through scanning the dentition of an orthodontic patient. These teeth models display a patient's teeth in an initial stage which may be a mal-occlusion stage or an intermediate stage achieved during the orthodontic treatment process. Then, an orthodontic treatment planning is performed and the teeth are positioned in a desired position, wherein the desired position may be another intermediate stage during the orthodontic treatment or the final stage of the treatment of the patient. 3D digital or virtual model of the teeth in initial stage is super imposed on the 3D digital or virtual model of the teeth in the desired position thereby creating a composit 3D digital or virtual model of the teeth. Gingiva obtained from the scanning data is also digitally superimposed on the combination of the 3D initial model and the 3D desired position model, i.e., the composit 3D digital or virtual model of the teeth. The resulting 3D digital or virtual composit model with gingiva is used to create a 3D composite physical dentition model using a 3D printing device or a 3D printer. Dimples of the desired shape and position are then created on the outer surface of the composite physical dentition model. The dimples create small pockets. These can be created using a dental hand piece, small drill or hand-held mill, like a Dremel tool by removing a small amount of material to make the dimple (pocket). Alternately, the dimples can be created on the composite 3D digital or virtual model of the teeth using the treatment planning workstation; and the 3D composite physical dentition model can be subsequently created using a 3D printing device or a 3D printerin a manner such that the 3D composite physical dentition model will automatically have dimples without requiring the manual process to create those dimples. The tooth positioning appliance is then created by molding plastic on the composite physical model via a vacuum forming process. During the plastic molding process buttons or protrusions are created on the plastic device, i.e., the tooth positioning appliance, corresponding to the dimples created on the composite model. The plastic device is then placed on the teeth like an aligner or a retainer. The buttons face the teeth surface and apply forces on the teeth to move the teeth in the desired position. The forces are designed to cause the desired translational, rotational or a torque movement, or a combination of movements to reposition one or more teeth.

The dimples and corresponding tooth positioning appliance tray protrusions or buttons are important because the physical model consists of the same teeth in two different positions, initial and final, initial and first intermediate stage, two intermediate stages of movement or last intermediate stage and final position. The tooth positioning appliances produced from these composite models often have larger tooth cavities because they allow more movement than a traditional aligner. The model dimples and tooth positioning appliance tray buttons provide a way to exert additional force when much of the tooth positioning appliance tooth cavity walls are not in contact with an individual tooth.

Treatment can be planned to move the teeth in stages. 3D composite physical model can be created again and again to accomplish the movement of teeth at each stage. This is accomplished by creating new dimples on the 3D composite physical model and then molding a corresponding new plastic device for moving the teeth to the next stage as needed.

When creating the dimples on the digital model prior to printing, the physical printed models include the dimples and the manual process of drilling out the dimples is not needed. The tooth positioning appliance tray production remains the same (vacuum forming over the physical model with dimples). Note in this case, software can be used to calculate the intended direction of movement for the stage and the preferred size and placement of the dimple/button to apply the additional tooth moving forces.

In another embodiment of the invention, the combination of the 3D initial dentition model and the 3D desired position dentition model (or the “virtual combination dentition model”) can be used to directly create the tooth positioning appliance using a 3D printing device. In this case the virtual dimples are created on the virtual combination dentition model, which in turn help to create the desired buttons of the tooth positioning appliance during the 3D printing process. As an additional embodiment, software can design the tooth positioning appliance with the buttons and can send the design data to a 3D printer for direct printing the tooth positioning appliance. It should be noted that these embodiments eliminate the intermediate step of creating the 3D composite physical model, saving time and reducing cost.

The tooth positioning appliance is created for treatment of the teeth in a single jaw. Two such appliances are required for treating teeth in both the jaws; one for the upper jaw and the other for the lower jaw.

The tooth positioning appliance described herein is similar to an aligner; and snaps on the teeth when in use. It can be removed when desired, and then re-snapped on the teeth.

The tooth positioning appliance disclosed herein makes it possible to have a hybrid orthodontic treatment for a patient wherein teeth in one jaw are treated with a tooth positioning appliance, and the teeth in the other jaw with a brace comprising a combination of brackets glued to the teeth and an archwire.

While a number of exemplary aspects and embodiments have been discussed above, those of skill in the art will recognize that modifications, permutations, additions and sub-combinations thereof are present in this disclosure. It is therefore intended that the following appended claims and claims hereafter introduced are interpreted to include all such modifications, permutations, additions and sub-combinations as are within their true spirit and scope.

We claim:

1. A tooth positioning appliance comprising:
an apparatus made from plastic that is placed on teeth in a jaw of a patient for repositioning said teeth during an orthodontic treatment;
wherein said apparatus has active buttons or protrusions, facing tooth surface; and
wherein said buttons are shaped to exert desired force on corresponding tooth to gradually reposition said tooth in a desired position.

2. The tooth positioning appliance of claim 1, wherein said buttons are shaped to cause lateral movement, or rotation or torque or a desired combination of these forces.

3. The tooth positioning appliance of claim 1, wherein said buttons are placed in labial or lingual positions on said tooth positioning appliance per the treatment plan.

4. The tooth positioning appliance of claim 3, wherein said buttons are positioned on lingual side alone, or labial side alone, or on both said lingual as well as said labial sides.

5. A method of making a tooth positioning appliance for repositioning teeth of a patient in a jaw, comprising the steps of:
(a) obtaining a three dimensional virtual model of teeth of said patient in an initial stage;
(b) creating a three dimensional virtual model of teeth of said patient in a desired stage;
(c) superimposing said three dimensional virtual model of said teeth of said patient in said initial stage on said three dimensional virtual model of said teeth of said patient in said desired stage, thereby creating a combined virtual model of said teeth of said patient;
(d) superimposing gingiva on said combined virtual model of said teeth of said patient;
thereby creating a combined virtual model of said teeth with gingiva of said patient;
(e) placing dimples of desired shapes at desired locations on said combined virtual model of said teeth with gingiva of said patient;
(f) creating a three dimensional composite physical model with dimples from said combined virtual model of said teeth with gingiva of said patient; and
(g) making said tooth positioning appliance by molding plastic on said three dimensional composite physical model; wherein buttons are created on said tooth positioning appliance corresponding to said dimples on said three dimensional composite physical model.
